(19) United States
(12) Patent Application Publication
(10) Pub. No.: US 2011/0003262 A1
(43) Pub. Date: Jan. 6, 2011

(54) Dental Appliance

(75) Inventors: Donald E. Frantz, Katy, TX (US); Michael D. Frantz, Port Townsend, WA (US); Joseph Lee Frantz, Austin, TX (US)

Correspondence Address: LEE & HAYES, PLLC, 601 W. RIVERSIDE AVENUE, SUITE 1400, SPOKANE, WA, 99201, US

(73) Assignee: Frantz Design Inc., Austin, TX (US)

(21) Appl. No.: 12/715,339

(22) Filed: Mar. 1, 2010

Related U.S. Application Data
(63) Continuation of application No. 29/328,620, filed on Nov. 26, 2008, now Pat. No. D611153.

(51) Int. Cl. A61C 7/00

(52) U.S. Cl. 433/2

(57) ABSTRACT

Disclosed is a mandibular positioning apparatus that uses elastic bands to pull the lower jaw forward including a set of plastic retention hooks, one on the right and one on the left of an upper plastic base, and a lower plastic base conforming to lower teeth with a vertical displacement on the base.

### BACKGROUND

Be it known that Donald Frantz and Michael Frantz have invented a new and ornamental design for a Dental Appliance of which the following is a specification, reference being had to the accompanying drawings, which form a part hereof.

### DESCRIPTION OF THE DRAWING FIGURES

FIG. 1 is a front perspective view of a dental appliance according to one implementation placed on a model of an exemplary mouth shown in broken lines for context;

FIG. 2 is a front perspective view of the dental appliance of FIG. 1;

FIG. 3 is a right side elevation view of the dental appliance of FIG. 1;

FIG. 4 is a left side elevation view of the dental appliance of FIG. 1;

FIG. 5 is a top elevation view of the dental appliance of FIG. 1;

FIG. 6 is a bottom elevation view of the dental appliance of FIG. 1;

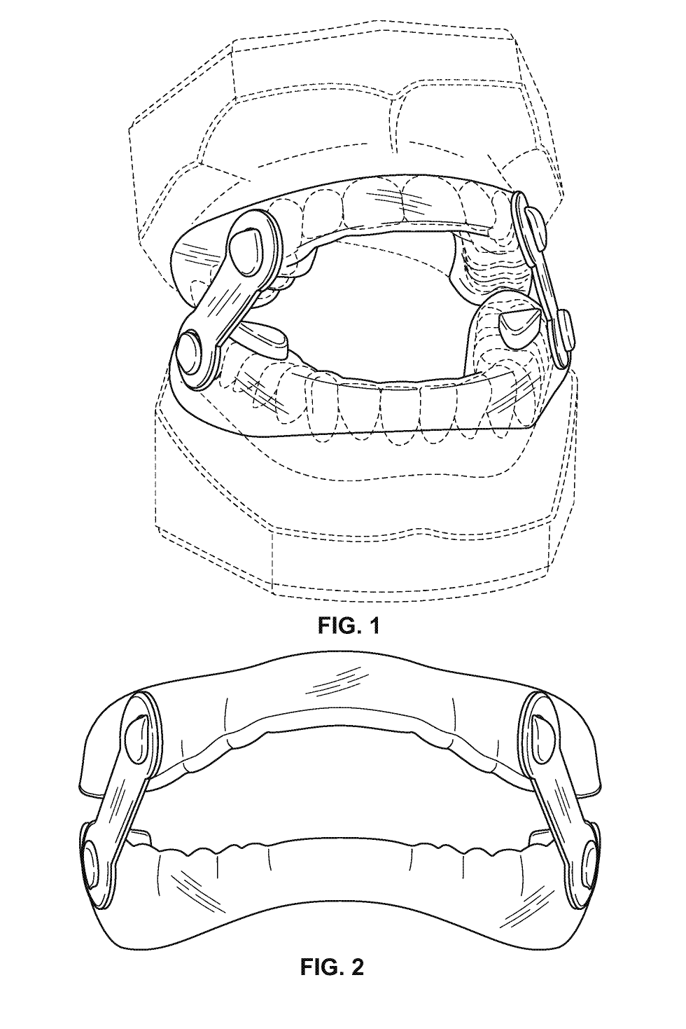

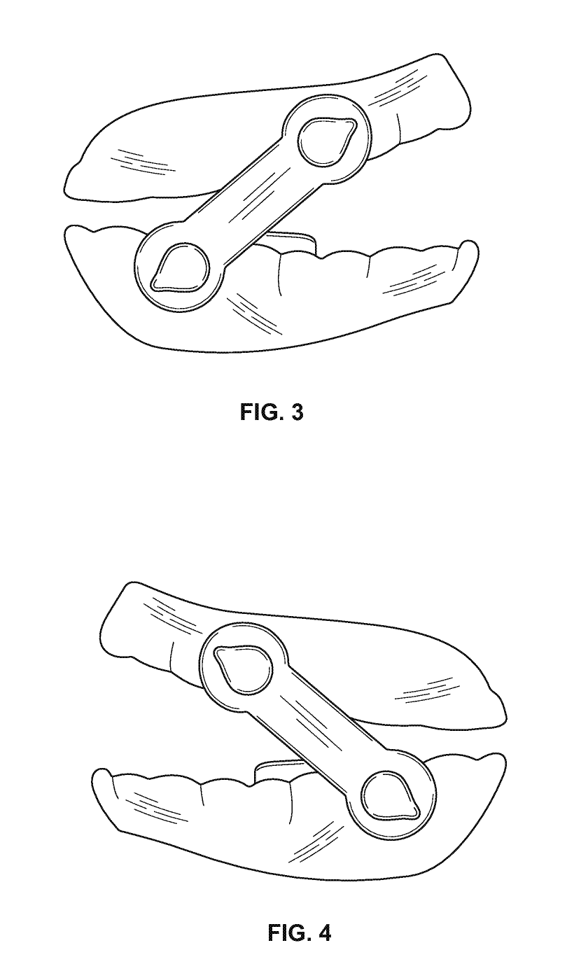

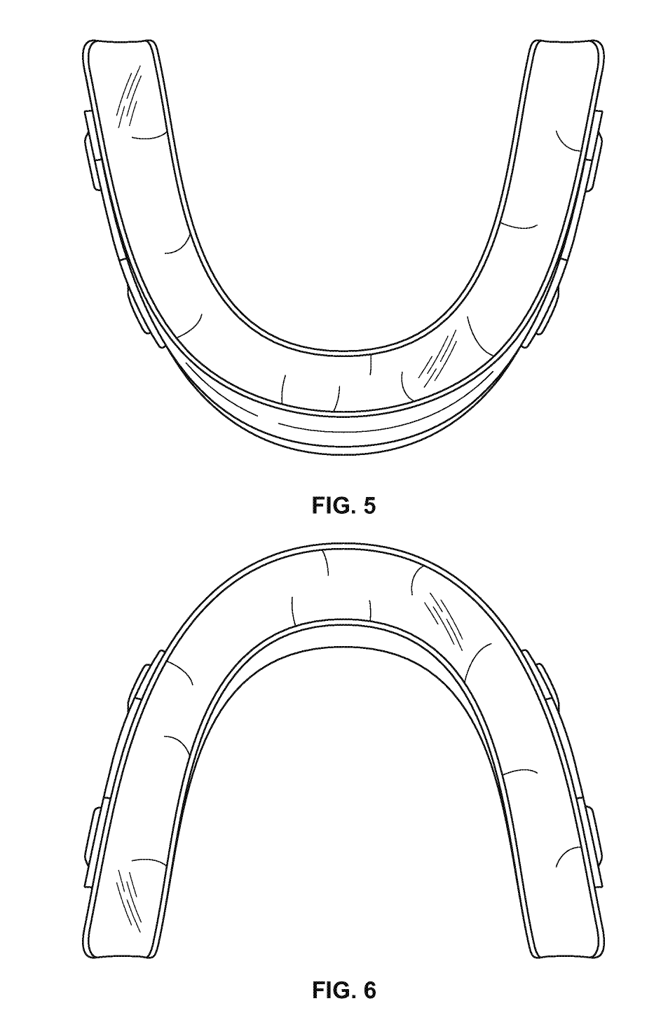

The broken lines are directed to an exemplary dental environment and are for illustrative purposes only. The broken lines form no part of the claimed design.

We claim:

1. The ornamental design for a dental appliance as shown and described.
